(19) United States
(12) Patent Application Publication
(10) Pub. No.: US 2010/0220033 A1
(43) Pub. Date: Sep. 2, 2010

(54) Broadband Antenna With Connection Device

(75) Inventors: Yao-Yuan Chang, Taipei (TW); Wen-Shyang Chen, Taipei County (TW); Tsung-Wen Chiu, Taipei County (TW); Fu-Ren Hsiao, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/412,828

(22) Filed: Mar. 27, 2009

(30) Foreign Application Priority Data
Feb. 27, 2009 (TW) 098106348

(51) Int. Cl. H01Q 1/50; H01Q 9/40

(52) U.S. Cl. 343/906; 343/831

(57) ABSTRACT

A broadband antenna with a connection device comprises a connection unit, a signal member and a radiation conductor. The connection unit has a first side and a second side. A fixing member is arranged on the first side. The signal member is arranged inside the connection unit and has a central cable. The central cable enters the first side and emerges from the second side to form a terminal. The radiation conductor is joined to the terminal of the central cable. The connection unit is engaged with a connection interface of an electronic device. A metallic material is used to fabricate the connection unit to increase the volume of the radiation conductor, whereby the transmission bandwidth of the antenna is greatly increased. The signal member is arranged inside and integrated with the connection unit, whereby the broadband antenna is easier to assemble, and the signal is less likely to attenuate.

### BACKGROUND OF THE INVENTION

1. Field of the Invention

The present invention relates to a broadband antenna with a connection device, particularly to a broadband antenna structure having a connection unit integrated with the antenna conductor.

2. Description of the Related Art

The technology integrating an antenna with a high-frequency connector is a composite technology integrating mechanical structure design, mechanics analysis and high-frequency electric measurement. At present, it has become the top target of the related manufacturers to effectively integrate an antenna with a connector to increase the application convenience and transmission bandwidth of the antenna.

Referring to FIG. 1, a conventional antenna-connector composite structure comprises a motherboard 1, an antenna 11, a connector 12, a ground cable 13 and a cableless communication module 14. The antenna 11 is electrically connected with a metallic casing 121 of the connector 12. The metallic casing 121 has a pin 122 on the bottom thereof, and the pin 122 is electrically connected to the cableless communication module 14 via the ground cable 13 on the motherboard 1. Thus, the antenna 11 is electrically connected to the cableless communication module 14 via the path of the metallic casing 121, the pin 122 and the ground cable 13.

In the abovementioned structure, the wiring path of the ground cable 13 must be carefully arranged lest the cable affect the signal transmission efficiency. Besides, the connector 12 is unlikely to provide the plug-and-play function because the connector 12 is fixedly installed in the interior of the motherboard 1. Further, the transmission efficiency of the radiation conductor is likely to be decreased because the antenna 11 is installed in the interior of the electronic device. Furthermore, the transmission bandwidth is hard to achieve the required communication standard because of the limited area of the radiation conductor.

### SUMMARY OF THE INVENTION

One objective of the present invention is to provide a broadband antenna with a connection device, wherein the connection unit is engaged to the connection interface of an electronic device, and the metallic connection unit increases the volume of the radiation conductor, whereby the transmission bandwidth of the antenna is greatly increased to achieve the communication standard required by the system.

Another objective of the present invention is to provide a broadband antenna with a connection device, wherein the signal member is arranged inside and integrated with the connection unit, whereby it is unnecessary to arrange the signal feeder cable around an electronic device, and whereby the broadband antenna is easy to assemble, and whereby the signal is less likely to attenuate.

Yet another objective of the present invention is to provide a broadband antenna with a connection device, wherein the antenna is not installed inside an electronic device but attached to the electronic device from the outside, whereby is decreased the factor retarding the transmission of the radiation conductor, and whereby is achieved the plug-and-play function of the broadband antenna.

A further objective of the present invention is to provide a broadband antenna with a connection device, wherein the length of the extension conductors can be adjusted to fine tune the impedance matching of the antenna system and increase the impedance bandwidth, and wherein the volume of the radiation conductor is raised to greatly increase the operation bandwidth.

To achieve the abovementioned objectives, the present invention proposes a broadband antenna with a connection device, which comprises a connection unit, a signal member and a radiation conductor. The connection unit has a first side and a second side; the first side and the second side respectively have openings. A fixing member is arranged on the first side. The signal member is arranged inside the connection unit and has a central cable. The central cable enters the first side and emerges from the second side to form a terminal outside the second side. The radiation conductor is joined to the terminal of the central cable, and the junction thereof forms a feeder point.

In a first embodiment of the present invention, the connection unit, the signal member and the radiation conductor form the basic structure of the broadband antenna. A metallic material is used to fabricate the connection unit, whereby the volume of the radiation conductor and the transmission bandwidth of the antenna are increased. The broadband antenna is engaged with a connection interface on the exterior of an electronic device via the connection unit, whereby is achieved a plug-and-play function of the broadband antenna. As the broadband antenna is installed outside an electronic device in the present invention, the factor retarding the transmission of the radiation conductor is decreased. As the signal member is arranged inside and integrated with the connection unit, the procedures of arranging a feeder cable around an electronic device is saved. Thus, the assembly process is simplified, and the yield is promoted. Further, the signal is less likely to attenuate thereby.

A second embodiment is also used to exemplify the present invention. The second embodiment is similar to the first embodiment except the second side of the connection unit has a plurality of extension conductors in the second embodiment. Appropriately adjusting the length of the extension conductors can control the resonant mode to have the required frequency band and fine tune the impedance matching of the antenna system to increase the impedance bandwidth of the system. Further, the volume of the radiation conductor is raised to greatly increase the operation bandwidth thereby.

Below, the embodiments are described in detail to make easily understood the technical contents of the present invention.

### BRIEF DESCRIPTION OF THE DRAWINGS

FIG. 1 is a perspective view schematically showing a conventional antenna-connector composite structure;

FIG. 2 is a perspective view schematically showing a broadband antenna with a connection device according to a first embodiment of the present invention;

FIG. 3 is a diagram showing the measurement results of the voltage standing wave ratio of the broadband antenna with a connection device according to the first embodiment of the present invention;

FIG. 4 is a perspective view schematically showing that the first embodiment of the present invention is applied to a portable computer;

FIG. 5 is a perspective view schematically showing a broadband antenna with a connection device according to a second embodiment of the present invention; and

FIG. 6 is a perspective view schematically showing a variation of the second embodiment of the present invention.

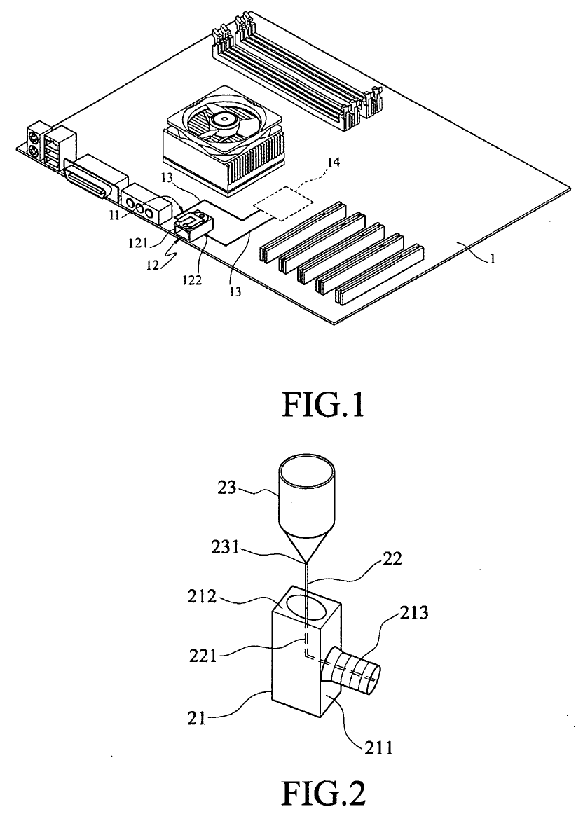

### DETAILED DESCRIPTION OF THE INVENTION

Referring to FIG. 2, a perspective view schematically showing a broadband antenna with a connection device according to a first embodiment of the present invention. In the first embodiment, the broadband antenna with a connection device comprises a connection unit 21, a signal member 22 and a radiation conductor 23. The connection unit 21 has a first side 211 and a second side 212; the first side 211 and the second side 212 respectively have openings. A fixing member 213 is arranged on the first side 211. The signal member 22 is arranged inside the connection unit 21 and has a central cable 221. The central cable 221 enters the first side 211 and emerges from the second side 212 to form a terminal outside the second side 212. The radiation conductor 23 is joined to the terminal of the central cable 221, and the junction thereof forms a feeder point 231.

In the first embodiment, the connection unit 21, the signal member 22 and the radiation conductor 23 form the basic structure of the broadband antenna. A metallic material is used to fabricate the connection unit 21, whereby the volume of the radiation conductor 23 and the transmission bandwidth of the antenna are increased. The fixing member 213 is fabricated to have a screwing or snap-fit function, whereby the broadband antenna can easily engage with a connection interface on the exterior of an electronic device anytime. Thus, the present invention achieves a plug-and-play function. As the antenna is installed outside an electronic device in the present invention, the factor retarding the transmission of the radiation conductor 23 is decreased. The radiation conductor 23 may be fabricated to have a shape of a column, a coned column or a rectangular parallelepiped to meet the requirement of the product or the fabrication process.

The connection unit 21 has a rectangular parallelepiped shape with a length of about 6 mm, a width of about 6 mm and a height of about 10 mm. In the first embodiment, the fixing member 213 is fabricated to have a screwing function and have a hollow-cylinder-like shape with a diameter of about 5 mm and a length of about 7 mm. The signal member 22 has a shape of a linear column with a length of about 20 mm. In the first embodiment, the radiation conductor 23 has a shape of a coned column; the upper cylinder portion thereof has a diameter of about 7 mm and a height of about 5 mm, and the lower cone portion has a height of about 4 mm.

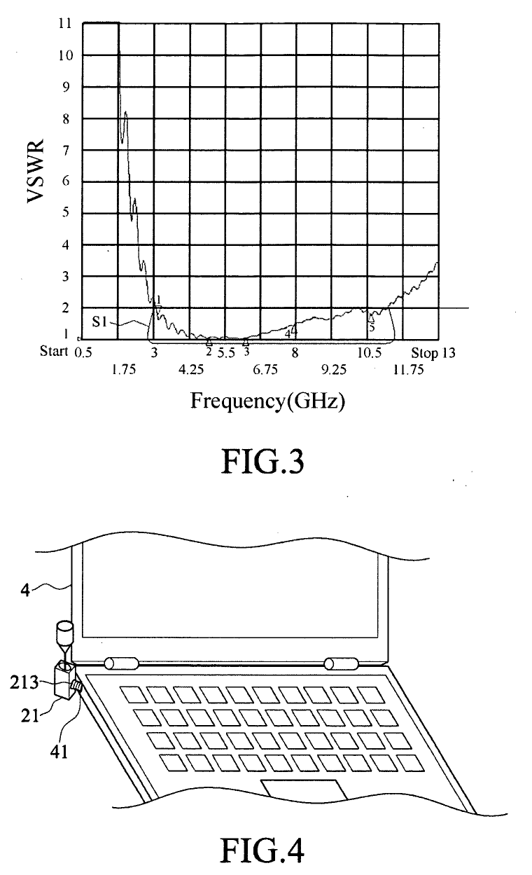

Referring to FIG. 3, a diagram shows the measurement results of the voltage standing wave ratio of the broadband antenna with a connection device according to the first embodiment of the present invention. When a bandwidth S1 is defined by a voltage standing wave ratio of 2, the bandwidth S1 ranges from 3.1 to 11 GHz, which covers the UWB system (3.1 GHz-10.6 GHz). From the measurement results, it is known that the antenna structure of the present invention indeed has a superior bandwidth.

Referring to FIG. 4, a perspective view schematically shows that the first embodiment of the present invention is applied to a portable computer. In the present invention, the fixing member 213 is fabricated to have a screwing or snap-fit function. When the user intends to use the broadband antenna, he engages the fixing member 213 of the connection unit 21 with an external connection interface 41 of a portable computer 4. When the broadband antenna is no more used, the fixing member 213 is disengaged from the external connection interface 41. Thereby, the broadband antenna of the present invention can be engaged or disengaged easily and fast. The present invention discloses a broadband antenna with a connection device to satisfy the requirement of a plug-and-play function. Further, the present invention can decrease the factor retarding the transmission of the radiation conductor, simplify the antenna layout, and reduce the difficulty of assemblage.

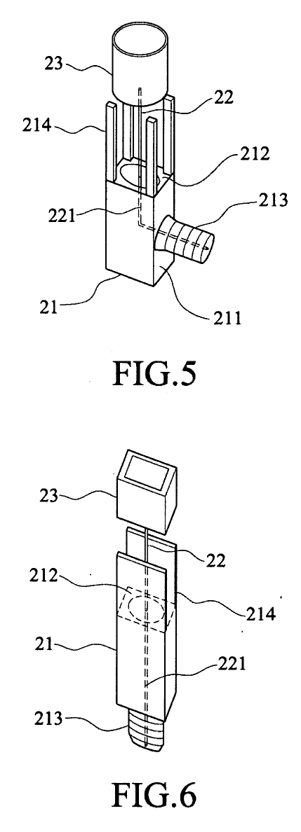

Referring to FIG. 5, a perspective view schematically shows a broadband antenna with a connection device according to a second embodiment of the present invention. The second embodiment is similar to the first embodiment except the second side 212 of the connection unit 21 has a plurality of extension conductors 214 with a shape of a long and thin rectangular parallelepiped rod in the second embodiment. Besides, the radiation conductor 23 has a column shape. Appropriately adjusting the length of the extension conductors 214 can control the resonant mode to have the required frequency band and fine tune the impedance matching of the antenna system to increase the impedance bandwidth of the system. The appearance of the radiation conductor 23 can be varied according to the product design.

Referring to FIG. 6, a perspective view schematically shows a variation of the second embodiment of the present invention. The variation of the second embodiment is similar to the second embodiment except the second side 212 of the connection unit 21 has a plurality of extension conductors 214 with a shape of a rectangular parallelepiped plate in the variation of the second embodiment. Besides, the radiation conductor 23 has a rectangular parallelepiped shape with dimensions identical to that of the connection units 21. In the variation of the second embodiment, the radiation conductor 23 and the connection unit 21 are designed to have identical shape and dimensions to simplify the product design and the mechanical stamping process.

The above description has fully demonstrated that the present invention possesses utility, novelty and non-obviousness and meets the conditions for a patent. However, the embodiments described above are only to exemplify the present invention but not to limit the scope of the present invention. Any equivalent modification or variation according to the spirit of the present invention is to be also included within the scope of the present invention.

What is claimed is:

1. A broadband antenna with a connection device, comprising
a connection unit having a first side and a second side, wherein said first side and said second side respectively have openings, and a fixing member is arranged on said first side;
a signal member arranged inside said connection unit and having a central cable, wherein said central cable enters said first side and emerges from said second side to form a terminal outside said second side; and
a radiation conductor joined to said terminal of said central cable, wherein a junction of said radiation conductor and said terminal forms a feeder point.

2. The broadband antenna with a connection device according to claim 1, wherein said connection unit is made of a metallic material.

3. The broadband antenna with a connection device according to claim 1, wherein said fixing member has a screwing function or a snap-fit function.

4. The broadband antenna with a connection device according to claim 1, wherein said radiation conductor has a shape of a column, a coned column or a rectangular parallelepiped.

5. A broadband antenna with a connection device, comprising
a connection unit having a first side and a second side, wherein said first side and said second side respectively have openings, and a fixing member is arranged on said first side;
a signal member arranged inside said connection unit and having a central cable, wherein said central cable enters said first side and emerges from said second side to form a terminal outside said second side;
a plurality of extension conductors arranged on said second side of connection unit; and
a radiation conductor joined to said terminal of said central cable, wherein a junction of said radiation conductor and said terminal forms a feeder point.

6. The broadband antenna with a connection device according to claim 5, wherein said connection unit is made of a metallic material.

7. The broadband antenna with a connection device according to claim 5, wherein said fixing member has a screwing function or a snap-fit function.

8. The broadband antenna with a connection device according to claim 5, wherein said radiation conductor has a shape of a column, a coned column or a rectangular parallelepiped.
